(19) United States
(12) Patent Application Publication
(10) Pub. No.: US 2022/0116406 A1
(43) Pub. Date: Apr. 14, 2022

(54) MALWARE DETECTION AND MITIGATION VIA A FORWARD PROXY SERVER

(71) Applicant: Microsoft Technology Licensing, LLC, Redmond, WA (US)

(72) Inventors: Guy LEWIN, New York City, NY (US); Tomer CHERNI, Ganei Tikva (IL); Daniel SENDEROVICH, Netanya (IL); Itamar NIDDAM, Tel Aviv (IL)

(21) Appl. No.: 17/068,157

(22) Filed: Oct. 12, 2020

(51) Int. Cl. H04L 29/06

(52) U.S. Cl. CPC H04L 63/145; H04L 63/1416; H04L 63/0281

(57) ABSTRACT

Methods, systems, apparatuses, and computer-readable storage mediums are described for performing malware detection and mitigation on behalf of a client device by a forward proxy server. For example, the client device is configured to route network traffic through the forward proxy server. The forward proxy server is configured to detect file transfer operations between the client device and a destination server. Responsive to detecting a file transfer operation, the forward proxy server obtains a copy of the file to be transferred and provides it to a malware identification service, which analyzes the file for malware. The malware identification service may execute on the forward proxy server or another server communicatively coupled thereto. Responsive to determining that the file has been compromised with malware, the forward proxy server performs one or more actions to mitigate the malware.

### BACKGROUND

There are many types of firewall and anti-malware software that can be installed on a computer to protect the computer from malware. However, as malware becomes more sophisticated, so does the anti-malware software utilized to protect the computer. This becomes problematic for older or simpler computing devices with limited processing capability, as such software may not be compatible with or operable on such devices. Even if such software is executable on a computing device, the amount of computing resources utilized by such software is ever-increasing, which adversely affects the performance of such devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums are described for performing malware detection and mitigation on behalf of a client device by a forward proxy server. For example, the client device is configured to route network traffic through the forward proxy server. The forward proxy server is configured to detect file transfer operations between the client device and a destination server. Responsive to detecting a file transfer operation, the forward proxy server obtains a copy of the file to be transferred and provides it to a malware identification service, which analyzes the file for malware. The malware identification service may execute on the forward proxy server or another server communicatively coupled thereto. Responsive to determining that the file has been compromised with malware, the forward proxy server performs one or more actions to mitigate the malware.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for performing malware detection via a forward proxy server in accordance with an example embodiment.

FIG. 2 shows a block diagram of a system for performing malware detection via a forward proxy server in accordance with another example embodiment.

FIG. 3 shows a flowchart of a method for detecting malware via a forward proxy server in accordance with an example embodiment.

FIG. 4 shows a flowchart of a method for detecting a file download operation via a forward proxy server in accordance with an example embodiment.

FIG. 5 shows a flowchart of a method for detecting a file upload operation via a forward proxy server in accordance with an example embodiment.

FIG. 6 shows a block diagram a system for detecting file upload and file download operations based on a notification received from a client application in accordance with an example embodiment.

FIG. 7 shows a flowchart of a method for detecting a file upload operation based on a notification received from a client application in accordance with an example embodiment.

FIG. 8 shows a flowchart of a method for detecting a file download operation based on a notification received from a client application in accordance with an example embodiment.

FIG. 9 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Embodiments described herein are directed to performing malware detection and mitigation on behalf of a client device by a forward proxy server. For example, the client device is configured to route network traffic through the forward proxy server. The forward proxy server is configured to detect file transfer operations between the client device and a destination server. Responsive to detecting a file transfer operation, the forward proxy server obtains a copy of the file to be transferred and provides it to a malware identification service, which analyzes the file for malware. The malware identification service may execute on the forward proxy server or another server communicatively coupled thereto. Responsive to determining that the file has been compromised with malware, the forward proxy server performs one or more actions to mitigate the malware.

The techniques described herein provide several technical advantages. For instance, the device for which malware detection and mitigation are performed is protected from malware, and therefore, is able to operate more securely and efficiently (i.e., the device is protected from the detrimental effects of malware). In addition, by performing malware detection and mitigation via a forward proxy server rather than on the client device itself, a number of computing resources (e.g., processor cycles, memory, and/or storage) are conserved on the client. This advantageously enables older and simpler computing devices with limited processing capability that are unable to run advanced anti-malware software to be protected from malware. Moreover, because the forward proxy server manages the malware identification service, the client no longer needs to be concerned with maintaining the malware identification service, for example, by updating malware definitions, installing updates, etc. This provides the additional benefit of conserving the client's network bandwidth, as the client no longer has to request the definitions and updates via the network.

In addition, by having the malware identification service execute on a device other than the client, additional types of malware protection beyond those supported by application stores or marketplaces from which applications (such as anti-malware software) are downloadable, may be implemented for the client circumvented. Accordingly, the embodiments described herein provide unconstrained malware protection for any type of client device.

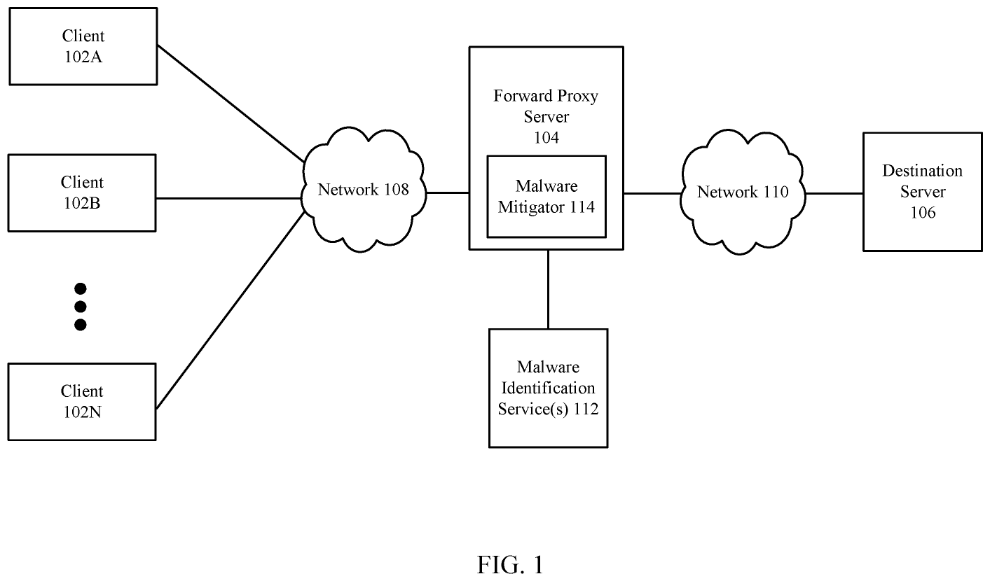

For instance, FIG. 1 shows a block diagram of a system 100 for performing malware detection via a forward proxy server in accordance with an embodiment. As shown in FIG. 1, system 100 includes a plurality of clients 102A-102N, a forward proxy server 104, and a destination server 106. Each of clients 102A-102N are communicatively coupled to forward proxy server 104 via a first network 108. Forward proxy server 104 is communicatively coupled to destination server 106 via a second network 110. Each of networks 108 and 110 may comprise one or more networks such as local area networks (LANs), wide area networks (WANs), enterprise networks, the Internet, etc., and may include one or more of wired and/or wireless portions.

Each of clients 102A-102N, forward proxy server 104 and destination server 106 are configured to implement a request-response protocol in which request messages are transmitted thereby and messages responsive to the request messages are received. In accordance with an embodiment, each of clients 102A-102N, forward proxy server 104 and destination server 106 are configured to transmit hypertext transfer protocol (HTTP) requests and receive HTTP responses. For example, each of clients 102A-102N are configured to execute a browser application (i.e. a Web browser) that is configured to transmit and receive such requests and responses. The browser application enables network information resources to be retrieved, presented, and traversed. An information resource may be accessed by the browser application using a network address, such as a uniform resource identifier (URI). Examples of information resources include web pages, images, videos, and other forms of content. Examples of a browser application include Microsoft Edge®, published by Microsoft Corp. of Redmond, Wash., Mozilla Firefox®, published by Mozilla Corp. of Mountain View, Calif., Safari®, published by Apple Inc. of Cupertino, Calif., and Google® Chrome, published by Google Inc. of Mountain View, Calif.

It is noted that the request-response protocol described above are purely exemplary and that each of clients 102A-102N, forward proxy server 104, and destination server 106 may be configured to implement and execute other request-response protocols.

Each of clients 102A-102N may be any type of stationary or mobile computing device, including a mobile computer or mobile computing device (e.g., a Microsoft® Surface® device, a laptop computer, a notebook computer, a tablet computer such as an Apple iPad™, a netbook, etc.), a wearable computing device (e.g., a head-mounted device including smart glasses such as Google® Glass™, etc.), or a stationary computing device such as a desktop computer or PC (personal computer).

Destination server 106 is configured to process and respond to incoming request messages (e.g., SOCKS4, SOCKS5, HTTP requests) originating from clients 102A-102N and received from forward proxy server 104. Destination server 106 provides resources and/or Web applications that are accessible by clients 102A-102N via forward proxy server 104. Examples of Web applications include, but are not limited to Web email applications (e.g., Gmail®, published by Google Inc.), Outlook.com™, published by Microsoft Corp, etc.), file sharing applications (e.g., Dropbox®, published by Dropbox, Inc. of San Francisco, Calif., etc.), productivity applications (e.g., Office 365®, published by Microsoft Corp, Google Apps™, published by Google, Inc., etc.), etc. It is noted that while FIG. 1 shows destination server 106 as a single server, destination server 106 may comprise any number of servers.

Each of clients 102A-102N are configured to communicate with forward proxy server 104. For instance, a user, for example, using a user interface (e.g., a graphical user interface (GUI) provided via a client, may configure his client to route some or all network traffic to forward proxy server 104. For instance, the user, using the user interface, may specify a uniform resource identifier (URI) associated with forward proxy server 104, such as, but no limited to a uniform resource locator (URL), an Internet Protocol (IP) address, etc.

Forward proxy server 104 comprises a malware mitigator 114, which is configured detect file transfer operations (e.g., file uploads or downloads) between clients 102A-102N and other entities, such as destination server 106. Malware mitigator 114 is further configured to determine whether one or more files associated with such file transfer operations are compromised with malware. For instance, upon detecting a file transfer operation, malware mitigator 114 may obtain the file(s) associated with the file transfer operation and provide a copy of the file(s) to one or more malware identification services 112. Malware identification service(s) 112 may comprise one or more anti-malware applications or services that are configured to detect whether file(s) are compromised with malware. Examples of anti-malware applications and services include, but are not limited to, Avast Antivirus™ published by Avast of Prague, Czech Republic, VirusTotal™ published by Chronicle Security (a subsidiary of Google Inc.) of Mountain View, Calif., and/or the like. In accordance with an embodiment, each of malware identification service(s) 112 may execute on a respective server communicatively coupled to forward proxy server 104. In accordance with another embodiment, each of malware identification service(s) 112 execute on forward proxy server 104.

Malware identification service(s) 112 analyze the received file(s) and determine whether such file(s) are compromised with malware. Responsive to determining that the file(s) are compromised with malware, malware identification service(s) 112 provides a first indication to malware mitigator 114 indicating that that the file(s) are compromised with malware. The indication may further specify the name and/or type of malware that compromised the file(s). Malware identification service(s) 112 may further remove and/or quarantine the identified malware and provide a version of the file(s) not containing the malware to malware mitigator 114. Responsive to determining that the file(s) are not compromised with malware, malware identification service(s) 112 provide a second indication to malware mitigator 114 indicating that the file(s) are not compromised with malware.

Responsive to receiving the first indication, malware mitigator 114 may perform an action to mitigate the malware. For instance, malware mitigator 114 may provide a notification that indicates that the detected file transfer operation is compromised with malware. For instance, malware mitigator 114 may provide a message to the user initiating the file transfer operation. The message may identify the file transfer operation, the file itself (e.g., the name of the file), specify that the file is compromised with malware, identify the malware identification service(s) 112 utilized to detect and identify the malware, etc. The message may comprise an e-mail message to an e-mail address associated with the user, a short messaging service (SMS) message to a phone number associated with the user (e.g., a phone number associated with a client of clients 102A-102C utilized by the user), etc., In another example, malware mitigator 114 may generate a file (e.g., a “dummy” or “tombstone” file) and provide the generated file to the user. The generated file may comprise the message, as described above.

The action may further comprise blocking the file transfer operation from being completed. For instance, malware mitigator 114 may prevent the file transfer operation from being completed. For instance, in an example in which a client of clients 102A-102N is attempting to upload a file to destination server 106, malware mitigator 114 may not establish a connection with destination server 106 and/or may not forward the upload request and/or file to destination server 106, thereby preventing the file associated with the file upload operation from reaching destination server 106. In an example in which a client of clients 102A-102N is attempting to download a file from destination server 106, malware mitigator 114 may prevent forward proxy server 104 from forwarding a response, comprising the file attempting to be download and received from destination server 106, to the requesting client of clients 102A-102N.

In another example, the action may further comprise encrypting the compromised file. For instance, malware mitigator 114 may encrypt the compromised file and provide the encrypted file to a user authorized to decrypt, view and/or analyze the file.

In yet another example, the action may also comprise allowing the file transfer operation to be completed, but providing a notification to the user indicating a warning to the user that the file is compromised with malware. For instance, malware mitigator 114 may enable the file transfer operation to be completed by forwarding the file to its designated destination and may also provide a notification (such as via a message or a dummy file, as described above) to the user that warns the user that the file has been compromised with malware.

Responsive to receiving the second indication, malware mitigator 114 enables the file transfer operation to be completed, for example, by forwarding the file to its designated designation.

Forward proxy server 104 may be implemented via a physical computing device, a virtual machine executing on a physical computing device, and/or any type of device comprising one or more processors and/or memories that is configured to process data. Examples of a computing device include but are not limited to, a desktop computer or PC (personal computer), a server, a computing node in a cloud-based environment, an Internet-of-Things (IoT) device, a personal digital assistant (PDA), a laptop computer, a notebook computer, a tablet computer, a netbook, a smart phone, a wearable computing device (e.g., a head-mounted device including smart glasses, a virtual headset, a smart watch, etc.) and/or the like. Alternatively, forward proxy server may be implemented as a software application that executes on a physical computing device or virtual machine or may be implemented as a containerized application configured to execute via a container engine executing on a physical computing device. An example of a container engine includes, but is not limited to Docker®, published by Docker®, Inc.

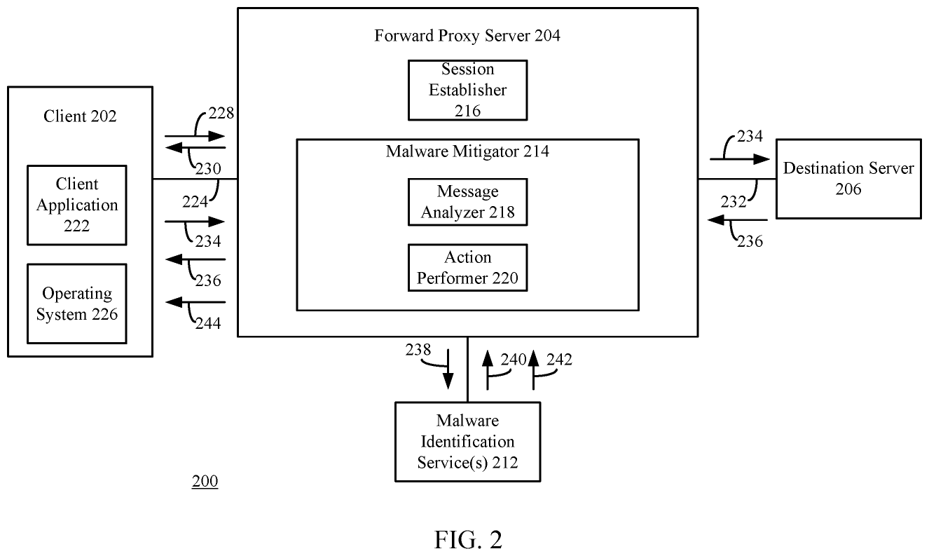

FIG. 2 shows a block diagram of a system 200 for performing malware detection via a forward proxy server in accordance with another embodiment. As shown in FIG. 2, system 200 includes a client 202, a forward proxy server 204, a destination server 206 and malware identification service(s) 212. Client 202 is an example of clients 202A-202N, forward proxy server 204 is an example of forward proxy server 104, destination server 206 is an example of destination server 106, and malware identification service(s) 212 are examples of malware identification service(s) 112, as respectively described above with reference to FIG. 1. As also shown in FIG. 2, forward proxy server 204 comprises a session establisher 216 and a malware mitigator 214. Malware mitigator 214 is an example of malware mitigator 114, as described above with reference to FIG. 1. Malware mitigator 214 comprises a message analyzer 218 and an action performer 220.

Client 202 comprises a client application 222 and an operating system 226. Client application 222 may be any type of software application or service, such as, a social networking application, messaging application, e-mail application, a file hosting application, a browser application, or any application configured to transmit and/or receive data objects. Examples of such applications include a Facebook®, LinkedIn®, Google Docs™, Microsoft® Office 365, Dropbox™, Microsoft Edge®, etc. Client application 222 may be configured to receive, create, generate, interact with, download, upload, delete, modify, access, and/or transmit data objects (e.g., data object 124). Examples of data objects include, but are not limited to, a data file, a database object (e.g., a table, a directory, etc.), structured data, unstructured data, semi-structured data, a data container, etc.

Client 202 is configured to transmit and/or receive network data packets (or network traffic) to and/or from computing devices (e.g., destination server 206) via forward proxy server 204. For instance, a user may configure client 202 such that all network traffic originating from client 202 is routed to forward proxy server 204. For example, a user, via a user interface (e.g., a graphical user interface) provided via operating system 226 executing on client 202, may specify a URI of forward proxy server 204, specify a setup script (or location thereof) that, when executed, configures client 202 to communicate with forward proxy server 204, etc. The network data packets transmitted from client 202 may originate from various applications executing on client 202, including, but not limited to client application 222. The network data packets may comprise request and/or response messages, among other types of messages and/or data.

To transmit request messages, operating system 226 first establishes a transport layer connection (or session) 224 with first reverse proxy server 204. In accordance with an embodiment, transport layer connection 224 is in accordance with a transmission control protocol (TCP), although the embodiments described herein are not so limited. To establish transport layer connection 224, operating system 226 transmits a request 228 to forward proxy server 204 that informs forward proxy server 204 about the client (i.e., client 202) attempting to initiate the transport layer connection. In accordance with an embodiment, request 228 comprises a SYN control message, which is in accordance with the TCP protocol. Request 228 is received by session establisher 216. Session establisher 216 responds to client 202 via a response 230. In accordance with an embodiment, response 230 comprises a SYN-ACK control message set, which is accordance with the TCP protocol. Client 202 may provide an acknowledgment (or ACK) control message in response to receiving response 230. Client 202 and session establisher 216 of forward proxy server 204 establish connection 224 based on a successful exchange of the control messages described above. After connection 224 has been established, client application 222 is enabled to provide and receive messages to and from forward proxy server 204.

For instance, client application 222 may provide a request message 234 intended for destination server 206 via connection 224. Request message 234 may specify a destination URI corresponding to destination server 206. Responsive to receiving request message 234, session establisher 216 may be configured to establish a transport layer connection 232 between forward proxy server 204 and destination server 206 (as identified via request message 234). In accordance with an embodiment, transport layer connection 232 is in accordance with the TCP protocol. Session establisher 216 may establish transport layer connection 232 in a similar manner as described above with reference to transport layer connection 224, in which SYN and ACK control messages are exchanged between session establisher 216 of forward proxy server 204 and destination server 206. Forward proxy server 204 provides request message 234 to destination server 206 via transport layer connection 232 after transport layer connection 232 is established. Connections 224 and 232 may be persistent connections. That is, connections 224 and 232 may remain open or active until they are terminated by client 202, forward proxy server 204, and/or destination server 206. Accordingly, connections 224 and 232 may be utilized to transmit any number of request messages and/or response messages.

Destination server 206 may provide a response message 236 responsive to request message 234 to forward proxy server 204 via connection 232, and forward proxy server 204 forwards response message 236 to client 202 via connection 224. In accordance with an embodiment, request message 234 and response message 236 are hypertext transfer protocol (HTTP)-based messages. Although, the embodiments described herein are not so limited. For instance, request message 234 and/or response message 236 may be in accordance with SOCKS4 or SOCKS5 protocol.

Malware mitigator 214 is configured to monitor network traffic received via connections 224 and 232 to detect file operations (e.g., file upload operations or file download operations). For instance, message analyzer 218 is configured to analyze request messages (e.g., request message 234) and/or response messages (e.g., response message 236) to detect such file operations. To detect a file upload operation, message analyzer 218 analyzes request message 234 to identify its type. For example, in an embodiment in which request message 234 is an HTTP request message, message analyzer 218 analyzes request message 234 to determine whether a request method thereof corresponds to a method for storing (or uploading) a file. Examples of such a request method include, but are not limited to PUT, POST, and/or the like. Responsive to determining that request message 234 specifies such a request method, message analyzer 218 analyzes request message 234 to identify a URI included in request message 234. Message analyzer 218 determines whether the URI corresponds to a file upload path (e.g., www.example.com/upload) of a web page or server (e.g., destination server 206) for uploading a file. Message analyzer 218 may maintain a data structure (e.g., a table) of URIs that correspond to known file upload paths. If the identified URI maps to a known file upload path included in the data structure, message analyzer 218 determines that the URI corresponds to a file upload path. Responsive to determining that the URI corresponds to a file upload path, message analyzer 218 provides a copy of the file identified by (and/or included in) request message 234 to malware identification service(s) 212. For example, as shown in FIG. 2, malware mitigator 214 provides a message 238 that comprises the copy of the file. In the event that message analyzer 218 determines that request message 234 does not specify such a request method and/or does not specify a file upload path, message analyzer 218 determines that request message 234 does not correspond to a file upload operation initiated by client 202.

To detect a file download operation, message analyzer 218 analyzes response messages received by forward proxy server 204 (e.g., response message 236). For example, in an embodiment in which response message 236 is an HTTP request message, message analyzer 218 analyzes a header of response message 236 to determine whether response message 236 is associated with a file download operation. In accordance with an embodiment in which response message 236 is an HTTP request message, message analyzer 218 may determine whether request message 236 comprises a Content-Disposition header. Such a header may specify a filename of the file to be downloaded and saved locally at client 202. If message analyzer 218 determines that such a header specifies a filename, message analyzer 218 provides a copy of the file identified by the filename (and included in response message 236) to malware identification service(s) 212 (e.g., via message 238). In the event that message analyzer 218 determines that response message 236 does not comprise a header that species a filename, message analyzer 218 determines that response message 236 does not correspond to a file download operation for which malware identification service(s) 212 is required.

Malware identification service(s) 212 analyzes the received file and determines whether such file(s) are compromised with malware. Responsive to determining that the file(s) are compromised with malware, malware identification service(s) 212 provides a first indication 240 to malware mitigator 214 indicating that that the file is compromised with malware. Indication 240 may further specify the name and/or type of malware that compromised the file. Malware identification service(s) 212 may further remove and/or quarantine the identified malware and provide a version of the file(s) not containing the malware to malware mitigator 212. Responsive to determining that the file(s) are not compromised with malware, malware identification service(s) 212 provide a second indication 242 to malware mitigator 212 indicating that the file(s) are not compromised with malware.

Responsive to receiving indication 240, malware mitigator 212 may perform an action to mitigate the malware. For instance, action performer 220 may provide a notification 244 that indicates that the file is compromised with malware. For instance, file action performer 220 may provide a message to the user initiating the file transfer operation via client 202. The message may identify the file transfer operation, the file itself (e.g., the name of the file), specify that the file is compromised with malware, identify the malware identification service(s) 212 utilized to detect and identify the malware, etc. The message may comprise an e-mail message to an e-mail address associated with the user, a short messaging service (SMS) message to a phone number associated with the user (e.g., a phone number associated with client 202), etc. In another example, malware mitigator 212 may generate a file (e.g., a “dummy” or “tombstone” file) and provide the file to the user. The file may comprise the message, as described above.

Action determiner 220 may further block the file transfer operation from being completed. For instance, in an example in which client 202 is attempting to upload a file to destination server 206 via a request message (e.g., request message 238), malware mitigator 212 may remove the file from the request message before forwarding it to destination server 206. Alternatively, malware mitigator 212 may remove connection 232 with destination server 106, thereby preventing the file from reaching destination server 106. In an example in which client 202 is attempting to download a file from destination server 206, malware mitigator 212 may prevent forward proxy server 104 from forwarding a response (e.g., response message 236), comprising the file attempting to be download and received from destination server 206, to client 202.

In another example, action performer 220 may encrypt the compromised file and provide the encrypted file to a user authorized to decrypt, view and/or analyze the file.

In yet another example, action performer 220 may also allow the file transfer operation to be completed, but provides a notification to the user of client 202 indicating a warning to the user that the file is compromised with malware. For instance, malware mitigator 212 may enable the file transfer operation to be completed by forwarding the file to its designated destination (e.g., destination server 206) and may also provide a notification (such as via a message or a via a dummy file, as described above) to client 202. A user may open the dummy file to view additional details regarding the failed file transfer operation.

Responsive to receiving indication 242, malware mitigator 212 enables the file transfer operation to be completed, for example, by forwarding the file to its designated designation. For instance, for a file upload operation, malware mitigator 212 causes forward proxy server 204 to forward request message 234 to destination server 206. For a file download operation, malware mitigator 212 causes forward proxy server 204 to forward response message 236 to client 202.

In accordance with an embodiment, message analyzer 218 provides the copy of the file to each of malware identification service(s) 212. Certain malware identification service(s) 212 may be more effective at detecting one type of malware than other malware identification service(s) 212. Accordingly, message analyzer 218 may provide the copy of the file to all malware identification service(s). Each of malware identification service(s) 212 may provide a respective indication 240 or 242 depending on whether it detects malware. Message analyzer 218 may determine that the file is compromised with malware if at least one of malware identification service(s) responds with indication 240.

In accordance with another embodiment, message analyzer 218 determines which of malware identification service(s) 212 to provide the copy of the file based on the file type (e.g., JPEG, PNG, GIF, PDF, DOC, etc.) of the file. Some of malware identification service(s) 212 may be more effective at identifying malware with respect to certain file types versus other malware identification service(s) 212. Accordingly, files of a first file type may be provided to a first malware identification service of malware identification service(s) 212, whereas files of a second file type may be provided to a second malware identification service of malware identification service(s) 212.

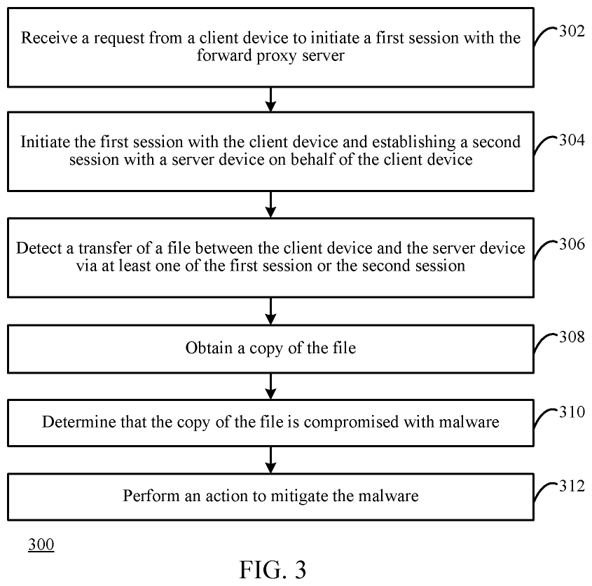

Accordingly, malware detection may be performed via a forward proxy server in many ways. For example, FIG. 3 shows a flowchart 300 of a method for detecting malware via a forward proxy server, according to an example embodiment. In an embodiment, flowchart 300 may be implemented by forward proxy server 204, as described in FIG. 2. Accordingly, flowchart 300 will be described with continued reference FIG. 2. Other structural and operational embodiments will be apparent to persons skilled in the relevant art(s) based on the following discussion regarding flowchart 300 and system 200.

Flowchart 300 of FIG. 3 begins with step 302. In step 302, a request is received from a client device to initiate a first session with the forward proxy server. For example, with reference to FIG. 2, session establisher 216 may receive a request 228 from operating system 226 of client 202 to initiate a first session with forward proxy server 204. Request 228 may be a SYN control message in an embodiment in which a TCP session is being established.

At step 304, responsive to receiving the request, the first session is initiated with the client device and a second session is established with a server device on behalf of the client device. For example, with reference to FIG. 2, session establisher 216 provides a response 230. Response may be an ACK control message in an embodiment in which a TCP session is being established. Client 202 and session establisher 216 of forward proxy server 204 establish the session by creating a connection 224 based on a successful exchange of the control messages described above. Session establisher 216 may further establish a session (or connection 232) with destination server 206 in a similar manner as described above with reference to connection 224.

At step 306, a transfer of a file between the client device and the server device is detected via at least one of the first session or the second session. For example, with reference to FIG. 2, message analyzer 218 may analyze messages received by forward proxy server (either via connections 224 and/or 232) and determine whether such messages correspond to a file transfer operation.

In accordance with one or more embodiments, the transfer comprises a file download operation from the server device. Additional details regarding detecting a file download operation is described below with reference to FIG. 4.

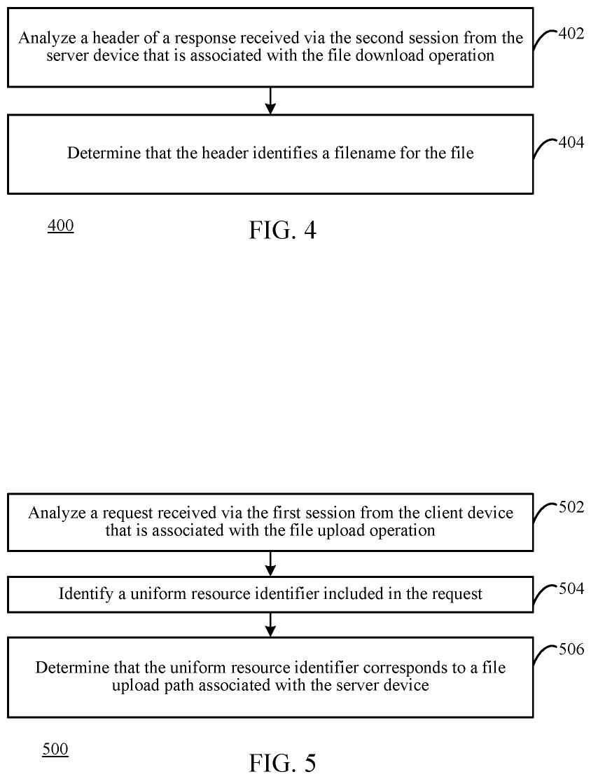

In accordance with one or more embodiments, the transfer comprises a file upload operation to the server device. Additional details regarding detecting a file upload operation is described below with reference to FIG. 5.

At step 308, responsive to detecting the transfer, a copy of the file is obtained. For example, with reference to FIG. 2, message analyzer 218 obtains a copy of the file.

At step 310, a determination is made that the copy of the file is compromised with malware. For example, with reference to FIG. 2, message analyzer 218 determines that the copy of the file is compromised with malware.

In accordance with one or more embodiments, determining that the copy of the file is compromised with malware comprises, providing the copy of the file to at least one malware identification service of a plurality of malware identification services that are each configured to analyze the copy of the file for malware, receiving an indication from the at least one malware identification service, the indication indicating whether the copy of the file has been compromised with malware, and based on the indication indicating that the copy of the file has been compromised with malware, determining that the file transfer operation is compromised with malware. For example, with reference to FIG. 2, message analyzer 218 provides a copy of the file via message 238 to malware identification service(s) 212. Malware identification service(s) 212 analyze the copy of the file to determine whether the copy of the file is compromised with malware. Responsive to determining that the copy of the file is compromised with malware, malware identification service(s) 212 provides indication 240 indicating that the copy of the file has been compromised. Responsive to determining that the copy of the file is not compromised with malware, malware identification service(s) 212 provides indication 242 indicating that the copy of the file has not been compromised. Malware mitigator 216 determines that the copy of the file is compromised based on receiving indication 240.

In accordance with one or more embodiments, the at least one malware identification service executes on a server device other than the forward proxy server. For example, with reference to FIG. 2, malware identification service(s) 212 execute on one or more server devices (not shown) different than forward proxy server 204.

In accordance with one or more embodiments, the at least one malware identification service to which the file is provided is selected based on a file type of the file. For example, with reference to FIG. 2, a JPEG file may be provided to a first malware identification service of malware identification service(s) 212, and a PDF file may be provided to a second malware identification service of malware identification service(s) 212.

At step 312, responsive to determining that the copy of the file is compromised with malware, an action is performed to mitigate the malware. For example, with reference to FIG. 2, responsive to determining that the copy of the file is compromised with malware, action performer 220 performs an action to mitigate the malware.

In accordance with one or more embodiments, the action comprises at least one of: providing a notification that indicates that the transfer is compromised with malware or preventing the transfer from being completed. For example, with reference to FIG. 2, action performer 220 may provide a notification 244 that indicates that the file is compromised with malware. For instance, notification 244 may comprise a message to the user initiating the file transfer operation via client 202. The message may identify the file transfer operation, the file itself (e.g., the name of the file), specify that the file is compromised with malware, identify the malware identification service(s) 212 utilized to detect and identify the malware, etc. The message may comprise an e-mail message to an e-mail address associated with the user, a short messaging service (SMS) message to a phone number associated with the user (e.g., a phone number associated with client 202), etc. In another example, malware mitigator 212 may generate a file (e.g., a “dummy” or “tombstone” file) and provide the file to the user. The file may comprise the message, as described above.

Action determiner 220 may further block the file transfer operation from being completed. For instance, in an example in which client 202 is attempting to upload a file to destination server 206 via a request message (e.g., request message 238), malware mitigator 212 may remove the file from the request message before forwarding it to destination server 206. Alternatively, malware mitigator 212 may terminate connection 232 with destination server 206, thereby preventing the file from reaching destination server 206. In an example in which client 202 is attempting to download a file from destination server 206, malware mitigator 212 may prevent forward proxy server 104 from forwarding a response (e.g., response message 236), comprising the file attempting to be download and received from destination server 206, to client 202.

FIG. 4 shows a flowchart 400 of a method for detecting a file download operation via a forward proxy server, according to an example embodiment. In an embodiment, flowchart 400 may be implemented by forward proxy server 204, as described in FIG. 2. Accordingly, flowchart 400 will be described with continued reference FIG. 2. Other structural and operational embodiments will be apparent to persons skilled in the relevant art(s) based on the following discussion regarding flowchart 400 and system 200.

Flowchart 400 of FIG. 4 begins with step 402. In step 402, a header of a response that is associated with the file download operation and that is received via the second session from the server device is analyzed. For example, with reference to FIG. 2, message analyzer 218 analyzes a header of response message 236 received via connection 232 to determine whether response message 236 is associated with a file download operation. In accordance with an embodiment in which response message 236 is an HTTP request message, message analyzer 218 may determine whether request message 236 comprises a Content-Disposition header.

At step 404, a determination is made that the header identifies a file name for the file. For example, with reference to FIG. 2, the header may specify a filename of the file to be downloaded and saved locally at client 202. If message analyzer 218 determines that such a header specifies a filename, message analyzer 218 determines detects that the transfer of the file between the client device and the server device.

FIG. 5 shows a flowchart 500 of a method for detecting a file upload operation via a forward proxy server, according to an example embodiment. In an embodiment, flowchart 500 may be implemented by forward proxy server 204, as described in FIG. 2. Accordingly, flowchart 500 will be described with continued reference FIG. 2. Other structural and operational embodiments will be apparent to persons skilled in the relevant art(s) based on the following discussion regarding flowchart 500 and system 200.

Flowchart 500 of FIG. 5 begins with step 502. In step 502, a request received via the first session from the client device that is associated with the file upload operation is analyzed. For example, with reference to FIG. 2, message analyzer 218 is configured to analyze request message 234 to identify the type of request message 234. For example, in an embodiment in which request message 234 is an HTTP request message, message analyzer 218 analyzes request message 234 to determine whether a request method thereof corresponds to a method for storing (or uploading) a file. Examples of such a request method include, but are not limited to PUT, POST, and/or the like.

In step 504, a uniform resource identifier included in the request is identified. For example, with reference to FIG. 2, responsive to determining that request message 234 specifies such a request method, message analyzer 218 analyzes request message 234 to identify a URI included in request message 234.

In step 506, a determination is made that the uniform resource identifier corresponds to a file upload path associated with the server device. For example, with reference to FIG. 2, message analyzer 218 determines whether the URI corresponds to a file upload path (e.g., www.example.com/upload) of a web page or server (e.g., destination server 206) for uploading a file. Message analyzer 218 may maintain a mapping of URIs that correspond to known file upload paths. If the identified URI maps to a known file upload path included in the mapping, message analyzer 218 determines that the URI corresponds to a file upload path. Responsive to determining that the URI corresponds to a file upload path, message analyzer 218 detects that a file upload operation is being performed.

An issue that arises with monitoring file uploads or downloads is that different web services have different protocols between the client side and the server side (e.g., form-multipart, different AJAX methods, JSON post). However, certain client applications (e.g., browser applications) implement the same API for receiving files from the client itself, no matter what the client-server protocol implementation is. These APIs are: (1) dragging and dropping files and directories (e.g., folders) into the browser; and (2) selecting files and directories from <input type=“file”/> (e.g., choosing files from a dialog box). By filtering these APIs at the first (i.e., topmost) Document Object Model (DOM) element on the capture phase, all file upload and download attempts can be monitored. In contrast, a proxy solution that only examines network traffic to accomplish file upload and download monitoring may not be able to identify all uploads. Embodiments described herein techniques for enabling malware mitigator 216 to detect file upload and download operations of documents in client 202 that can be accessed by client application 222. In particular, client application 222 may provide a notification to malware mitigator 214 that indicates that a user is attempting a file upload or download operation via client application 222.

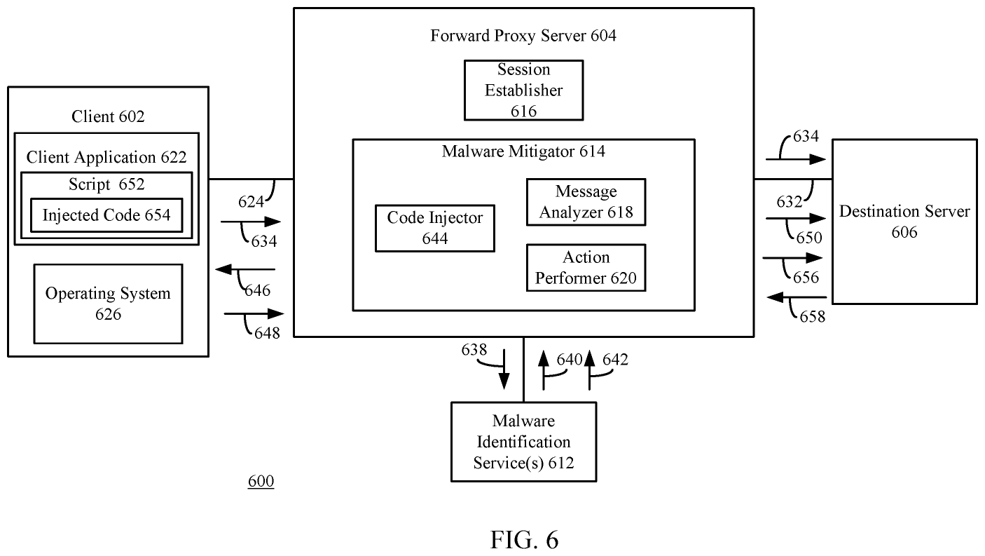

FIG. 6 shows a block diagram of a system 600 for detecting file upload and file download operations based on a notification received from a client application in accordance with an example embodiment. As shown in FIG. 6, system 600 comprises a client 602, a forward proxy server 604, a destination server 606, and malware identification service(s) 612. Client 602, forward proxy server 604, destination server 606, and malware identification service(s) 612 are examples of client 202, forward proxy server 204, destination server 206, and malware identification service(s) 212, as described above with reference to FIG. 2. Client 602 and forward proxy server 604 are communicatively coupled via connection 624, and forward proxy server 604 and destination server 606 are communicatively coupled via connection 632. Connections 624 and 632 are examples of connections 224 and 232 as respectively described above with reference to FIG. 2. Client 602 comprises a client application 622 and an operating system 626, which are examples of client application 222 and operating system 226, as described above with reference to FIG. 2. Forward proxy server 604 comprises a session establisher 616 and a malware mitigator 614, which are examples of session establisher 216 and malware mitigator 214, as described above with reference to FIG. 2. Malware mitigator 614 comprises a message analyzer 618 and an action performer 620, which are examples of message analyzer 218 and action performer 220, as described above with reference to FIG. 2. Malware mitigator 614 further comprises a code injector 644.

To enable client application 622 to provide notifications that a user is attempting a file upload or file download operation to destination server 606, malware mitigator 614 is configured to inject event monitoring code (e.g., script code, such as JavaScript) in file(s) (e.g., a Web page, a script, etc.) provided to client 602. For instance, client application 622 may provide a request message 634 to download a script from destination server 606. Request message 634 is an example of request message 234, as described above with reference to FIG. 2. Forward proxy server 604 forwards request message 634 to destination server 606. In response, destination server 606 provides a response message 636 comprising the requested script to forward proxy server 604. Response message 636 is an example of response message 236, as described above with reference to FIG. 2. Code injector 644 is configured to identify code in the script that can prompt a file upload event and/or a file download event that occurs on client 602. For instance, code injector 644 may parse the code of the script looking for commands, function calls, and/or setting of variables that can prompt an upload event and/or download event of client-side generated content at client 602. In some embodiments, code injector 644 may use an abstract syntax tree (AST) to identify code that can prompt an upload event and/or download event of a client-side generated content. An AST is a tree representation of the abstract syntactic structure of code written in a programming language. Each node of the AST may denote a construct occurring in the code. For example, code injector 644 may build an AST of the code of the script and traverse the AST looking for nodes that include commands, function calls, and/or setting of variables that can prompt an upload event or download event of client-side generated content at client 602.

Code injection 644 is configured to inject event monitoring code into the received script and provides the modified script to client 602 via a response message 646. The event monitoring code may be injected by “wrapping” the identified code with replacement functions or “hooks”. Hooks are code that may handle intercepted function calls, events, or messages. Client 602 stores the modified script locally. For instance, as shown in FIG. 6, client application 622 comprises script 652, which has been modified with event monitoring code 654.

Event monitoring code 654 is executed by the application that requested script 652 (e.g., client application 622). Event monitoring code 654 is configured to detect an action (e.g., a file upload operation, a file download operation, etc.) performed via client application 622. Examples of file upload operations that may be detected include, but are not limited to, a dragging and dropping action in which a file to be uploaded is dragged into a user interface for uploading files, a dialog box action in which a dialog box for uploading a file is interacted with, etc. Examples of file download operations that may be detected include, but are not limited to, detecting a prompt displayed to a user for downloading a file.

Responsive to detecting a file upload, event monitoring code 654 provides a request 648 to forward proxy server 604 that includes the file that client application 622 intends to upload. In accordance with an embodiment, request 648 is a synchronous XmlHttpRequest (XHR). Malware mitigator 614 provides a copy of the file to malware identification service(s) 612 via a message 638. Message 638 is an example of message 238, as described above with reference to FIG. 2. Malware identification service(s) 612 determine whether the file has been compromised with malware, as described above with reference to FIG. 2. Responsive to receiving an indication 642 that the file is not compromised with malware, malware mitigator 614 may provide the copy of the file to destination server 606 via a request message 650. Indication 642 is an example of indication 242, as described above with reference to FIG. 2. Responsive to receiving an indication 640 that the file is compromised with malware, action performer 620 may provide a notification to client 602 indicating as such, as described above with reference to FIG. 2.

Responsive to detecting a file download, event monitoring code 654 provides a request (e.g., request 648), which comprises an identifier of the filename attempting to be downloaded by client application 622 from destination server 606. Message analyzer 618 analyzes the request to identify the filename and provides a request 656 for the file identified by the filename to destination server 606. Destination server 606 provides a response 658 to forward proxy server 604 comprising the file. Malware mitigator 614 provides the file to malware identification service(s) 612 via a message (e.g., message 638). Malware identification service(s) 612 determine whether the file has been compromised with malware, as described above with reference to FIG. 2. Responsive to receiving an indication 642 that the file is not compromised with malware, malware mitigator 614 may provide the copy of the file to destination server 606 via a request message 650. Indication 642 is an example of indication 242, as described above with reference to FIG. 2. Responsive to receiving an indication 640 that the file is compromised with malware, action performer 620 may provide a notification to client 602 indicating as such, as described above with reference to FIG. 2.

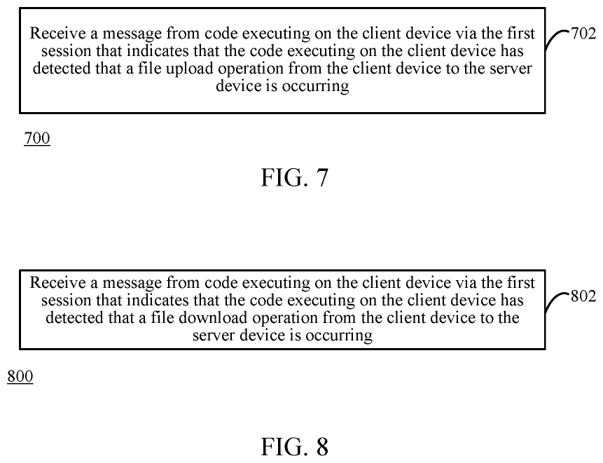

Accordingly, file upload and file download operations may be detected based on notifications received from a client application in many ways. For example, FIG. 7 shows a flowchart 700 of a method for detecting a file upload operation based on a notification received from a client application in accordance with an example embodiment. In an embodiment, flowchart 700 may be implemented by forward proxy server 604, as described in FIG. 6. Accordingly, flowchart 700 will be described with continued reference FIG. 6. Other structural and operational embodiments will be apparent to persons skilled in the relevant art(s) based on the following discussion regarding flowchart 700 and system 600.

Flowchart 700 of FIG. 7 comprises a step 702. In step 702, a message from code executing on the client device via the first session that indicates that the code executing on the client device has detected that a file upload operation from the client device to the server device is occurring is received. For example, with reference to FIG. 6, forward proxy server 604 may receive a message (e.g., message 624) that is issued by event monitoring code 654 executing on client 602. Message 624 indicates that event monitoring code 654 has detected a file upload operation from client 602 to destination server 606 is occurring.

FIG. 8 shows a flowchart 800 of a method for detecting a file download operation based on a notification received from a client application in accordance with an example embodiment. In an embodiment, flowchart 800 may be implemented by forward proxy server 604, as described in FIG. 6. Accordingly, flowchart 800 will be described with continued reference FIG. 6. Other structural and operational embodiments will be apparent to persons skilled in the relevant art(s) based on the following discussion regarding flowchart 800 and system 600.

Flowchart 800 of FIG. 8 comprises a step 802. In step 802, a message from code executing on the client device via the first session that indicates that the code executing on the client device has detected that a file download operation from the client device to the server device is occurring is received. For example, with reference to FIG. 6, forward proxy server 604 may receive a message (e.g., message 624) that is issued by event monitoring code 654 executing on client 602. Message 624 indicates that event monitoring code 654 has detected a file download operation from client 602 to destination server 606 is occurring.

### III. Example Computer System Implementation

Clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800 may be implemented in hardware, or hardware combined with one or both of software and/or firmware. For example, clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800 may be implemented as computer program code/instructions configured to be executed in one or more processors and stored in a computer readable storage medium.

Alternatively, clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800 may be implemented as hardware logic/electrical circuitry.

For instance, in an embodiment, one or more, in any combination, of clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

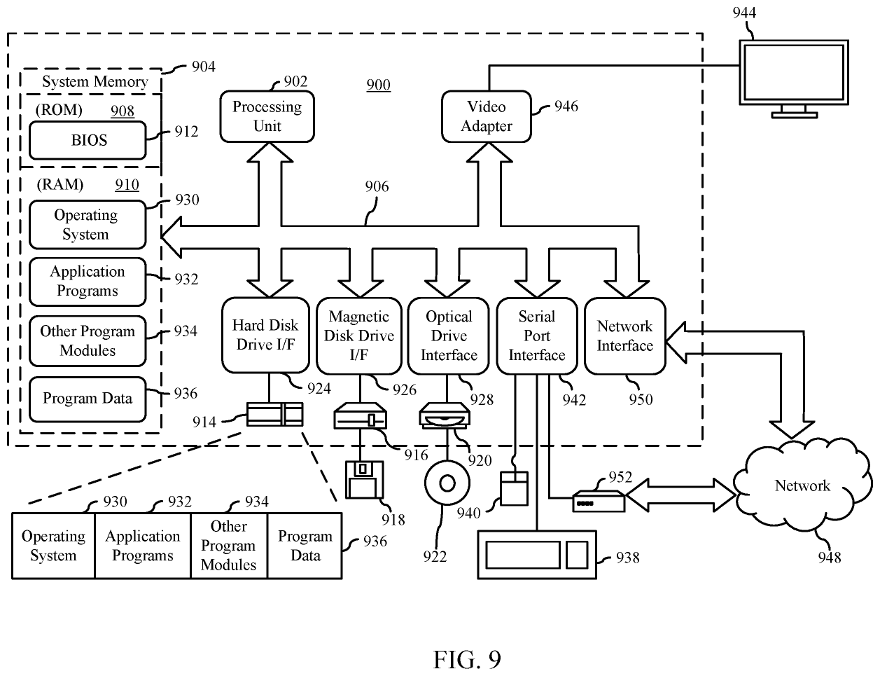

FIG. 9 depicts an exemplary implementation of a computing device 900 in which embodiments may be implemented. For example, clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800 and/or alternative features. The description of computing device 900 provided herein is provided for purposes of illustration, and is not intended to be limiting. Embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random-access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing any of the features of clients 102A-102N, forward proxy server 104, destination server 106, malware identification service(s) 112, client 202, forward proxy server 204, destination server 206, client application 222, operating system 226, session establisher 216, malware mitigator 214, message analyzer 218, action performer 220, malware identification service(s) 212, client 602, forward proxy server 604, destination server 606, client application 622, operating system 626, session establisher 616, malware mitigator 614, message analyzer 618, action performer 620, code injector 644, malware identification service(s) 612, and/or flowcharts 300, 400, 500, 700 and/or 800, and/or further embodiments described herein.

A user may enter commands and information into computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

A method implemented by a forward proxy server is described herein. The method comprises: receiving a request from a client device to initiate a first session with the forward proxy server; responsive to receiving the request, initiating the first session with the client device and establishing a second session with a server device on behalf of the client device; detecting a transfer of a file between the client device and the server device via at least one of the first session or the second session; responsive to detecting the transfer, obtaining a copy of the file; determining that the copy of the file is compromised with malware; and responsive to determining that the copy of the file is compromised with malware, performing an action to mitigate the malware.

In one embodiment of the foregoing method, the action comprises one or more of: providing a notification that indicates that the transfer is compromised with malware; or preventing the transfer from being completed.

In one embodiment of the foregoing method, determining that the copy of the file is compromised with malware comprises: providing the copy of the file to at least one malware identification service of a plurality of malware identification services that are each configured to analyze the copy of the file for malware; receiving an indication from the at least one malware identification service, the indication indicating whether the copy of the file has been compromised with malware; and based on the indication indicating that the copy of the file has been compromised with malware, determining that the copy of the file is compromised with malware.

In one embodiment of the foregoing method, the at least one malware identification service executes on a server device other than the forward proxy server.

In one embodiment of the foregoing method, the at least one malware identification service to which the file is provided is selected based on a file type of the file.

In one embodiment of the foregoing method, the transfer comprises a file download operation from the server device, wherein detecting the transfer via at least one of the first session or the second session comprises: analyzing a header of a response that is associated with the file download operation and that is received via the second session from the server device that is associated with the file download operation; and determining that the header identifies a filename for the file.

In one embodiment of the foregoing method, the transfer comprises a file upload operation to the server device, wherein detecting the transfer via at least one of the first session or the second session comprises: analyzing a request received via the first session from the client device that is associated with the file upload operation; identifying a uniform resource identifier included in the request; and determining that the uniform resource identifier corresponds to a file upload path associated with the server device.

In one embodiment of the foregoing method, detecting the transfer between the client device and the server device comprises: receiving a message from code executing on the client device via the first session that indicates that the code executing on the client device has detected that a file upload operation from the client device to the server device is occurring.

In one embodiment of the foregoing method, detecting the transfer between the client device and the server device comprises: receiving a message from code executing on the client device via the first session that indicates that the code executing on the client device has detected that a file download operation from the client device to the server device is occurring.

A forward proxy server is also described herein. The forward proxy server comprises: at least one processor circuit; and at least one memory that stores program code configured to be executed by the at least one processor circuit, the program code comprising: a session establisher configured to: receive a request from a client device to initiate a first session with the forward proxy server; responsive to receiving the request, initiate the first session with the client device and establish a second session with a server device on behalf of the client device; and a malware mitigator configured to: detect a transfer of a file between the client device and the server device via at least one of the first session or the second session; responsive to detecting the transfer, obtain a copy of the file; determine that the copy of the file is compromised with malware; and responsive to determining that the copy of the file is compromised with malware, perform an action to mitigate the malware.

In one embodiment of the foregoing forward proxy server, the action comprises one or more of: providing a notification that indicates that the transfer is compromised with malware; or preventing the transfer from being completed.

In one embodiment of the foregoing forward proxy server, malware mitigator determines that the copy of the file is compromised with malware by: providing the copy of the file to at least one malware identification service of a plurality of malware identification services that are each configured to analyze the copy of the file for malware; receiving an indication from the at least one malware identification service, the indication indicating whether the copy of the file has been compromised with malware; and based on the indication indicating that the copy of the file has been compromised with malware, determining that the copy of the file is compromised with malware.

In one embodiment of the foregoing forward proxy server, the at least one malware identification service executes on a server device other than the forward proxy server.

In one embodiment of the foregoing forward proxy server, the at least one malware identification service to which the file is provided is selected based on a file type of the file.

In one embodiment of the foregoing forward proxy server, the transfer comprises a file download operation from the server device, and wherein the malware mitigator detects the transfer via at least one of the first session or the second session by: analyzing a header of a response that is associated with the file download operation and that is received via the second session from the server device; and determining that the header identifies a filename for the file.

In one embodiment of the foregoing forward proxy server, the transfer comprises a file upload operation to the server device, wherein the malware mitigator detects the transfer via at least one of the first session or the second session by: analyzing a request received via the first session from the client device that is associated with the file upload operation; identifying a uniform resource identifier included in the request; and determining that the uniform resource identifier corresponds to a file upload path associated with the server device.

In one embodiment of the foregoing forward proxy server, the malware mitigator detects the transfer between the client device and the server device by: receiving a message from code executing on the client device via the first session that indicates that the code executing on the client device has detected that a file upload operation from the client device to the server device is occurring.

In one embodiment of the foregoing forward proxy server, the malware mitigator detects the transfer between the client device and the server device by: receiving a message from code executing on the client device via the first session that indicates that the code executing on the client device has detected that a file download operation from the client device to the server device is occurring.

A computer-readable storage medium having program instructions recorded thereon that, when executed by at least one processor of a forward proxy server, perform a method, the method comprising. The method comprises: receiving a request from a client device to initiate a first session with the forward proxy server; responsive to receiving the request, initiating the first session with the client device and establishing a second session with a server device on behalf of the client device; detecting a transfer of a file between the client device and the server device via at least one of the first session or the second session; responsive to detecting the transfer, obtaining a copy of the file; determining that the copy of the file is compromised with malware; and responsive to determining that the copy of the file is compromised with malware, performing an action to mitigate the malware.

In one embodiment of the foregoing computer-readable storage medium, the action comprises one or more of: providing a notification that indicates that the transfer is compromised with malware; or preventing the transfer from being completed.

### V. CONCLUSION

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A method implemented by a forward proxy server, comprising:
receiving a request from a client device to initiate a first session with the forward proxy server;
responsive to receiving the request, initiating the first session with the client device and establishing a second session with a server device on behalf of the client device;
detecting a transfer of a file between the client device and the server device via at least one of the first session or the second session;
responsive to detecting the transfer, obtaining a copy of the file;
determining that the copy of the file is compromised with malware; and
responsive to determining that the copy of the file is compromised with malware, performing an action to mitigate the malware.

2. The method of claim 1, wherein the action comprises one or more of:
providing a notification that indicates that the transfer is compromised with malware; or
preventing the transfer from being completed.

3. The method of claim 1, wherein determining that the copy of the file is compromised with malware comprises:
providing the copy of the file to at least one malware identification service of a plurality of malware identification services that are each configured to analyze the copy of the file for malware;
receiving an indication from the at least one malware identification service, the indication indicating whether the copy of the file has been compromised with malware; and
based on the indication indicating that the copy of the file has been compromised with malware, determining that the copy of the file is compromised with malware.

4. The method of claim 3, wherein the at least one malware identification service executes on a server device other than the forward proxy server.

5. The method of claim 3, wherein the at least one malware identification service to which the file is provided is selected based on a file type of the file.

6. The method of claim 1, wherein the transfer comprises a file download operation from the server device, and wherein detecting the transfer via at least one of the first session or the second session comprises:
analyzing a header of a response that is associated with the file download operation and that is received via the second session from the server device; and
determining that the header identifies a filename for the file.

7. The method of claim 1, wherein the transfer comprises a file upload operation to the server device, wherein detecting the transfer via at least one of the first session or the second session comprises:
analyzing a request received via the first session from the client device that is associated with the file upload operation;
identifying a uniform resource identifier included in the request; and
determining that the uniform resource identifier corresponds to a file upload path associated with the server device.

8. The method of claim 1, wherein detecting the transfer between the client device and the server device comprises:
receiving a message from code executing on the client device via the first session that indicates that the code executing on the client device has detected that a file upload operation from the client device to the server device is occurring.

9. The method of claim 1, wherein detecting the transfer between the client device and the server device comprises:
receiving a message from code executing on the client device via the first session that indicates that the code executing on the client device has detected that a file download operation from the client device to the server device is occurring.

10. A forward proxy server, comprising:
at least one processor circuit; and
at least one memory that stores program code configured to be executed by the at least one processor circuit, the program code comprising:
a session establisher configured to:
receive a request from a client device to initiate a first session with the forward proxy server;
responsive to receiving the request, initiate the first session with the client device and establish a second session with a server device on behalf of the client device; and
a malware mitigator configured to:
detect a transfer of a file between the client device and the server device via at least one of the first session or the second session;
responsive to detecting the transfer, obtain a copy of the file;
determine that the copy of the file is compromised with malware; and
responsive to determining that the copy of the file is compromised with malware, perform an action to mitigate the malware.

11. The forward proxy server of claim 10, wherein the action comprises one or more of:
providing a notification that indicates that the transfer is compromised with malware; or
preventing the transfer from being completed.

12. The forward proxy server of claim 10, wherein malware mitigator determines that the copy of the file is compromised with malware by:
providing the copy of the file to at least one malware identification service of a plurality of malware identification services that are each configured to analyze the copy of the file for malware;
receiving an indication from the at least one malware identification service, the indication indicating whether the copy of the file has been compromised with malware; and
based on the indication indicating that the copy of the file has been compromised with malware, determining that the copy of the file is compromised with malware.

13. The forward proxy server of claim 12, wherein the at least one malware identification service executes on a server device other than the forward proxy server.

14. The forward proxy server of claim 12, wherein the at least one malware identification service to which the file is provided is selected based on a file type of the file.

15. The forward proxy server of claim 10, wherein the transfer comprises a file download operation from the server device, and wherein the malware mitigator detects the transfer via at least one of the first session or the second session by:
analyzing a header of a response that is associated with the file download operation and that is received via the second session from the server device; and
determining that the header identifies a filename for the file.

16. The forward proxy server of claim 10, wherein the transfer comprises a file upload operation to the server device, wherein the malware mitigator detects the transfer via at least one of the first session or the second session by:
analyzing a request received via the first session from the client device that is associated with the file upload operation;
identifying a uniform resource identifier included in the request; and
determining that the uniform resource identifier corresponds to a file upload path associated with the server device.

17. The forward proxy server of claim 10, wherein the malware mitigator detects the transfer between the client device and the server device by:
receiving a message from code executing on the client device via the first session that indicates that the code executing on the client device has detected that a file upload operation from the client device to the server device is occurring.

18. The forward proxy server of claim 10, wherein the malware mitigator detects the transfer between the client device and the server device by:
receiving a message from code executing on the client device via the first session that indicates that the code executing on the client device has detected that a file download operation from the client device to the server device is occurring.

19. A computer-readable storage medium having program instructions recorded thereon that, when executed by at least one processor of a forward proxy server, perform a method, the method comprising:
receiving a request from a client device to initiate a first session with the forward proxy server;
responsive to receiving the request, initiating the first session with the client device and establishing a second session with a server device on behalf of the client device;
detecting a transfer of a file between the client device and the server device via at least one of the first session or the second session;
responsive to detecting the transfer, obtaining a copy of the file;
determining that the copy of the file is compromised with malware; and
responsive to determining that the copy of the file is compromised with malware, performing an action to mitigate the malware.

20. The computer-readable storage medium of claim 19, wherein the action comprises one or more of:
providing a notification that indicates that the transfer is compromised with malware; or
preventing the transfer from being completed.
